(19) United States
(12) Patent Application Publication
(10) Pub. No.: US 2020/0231480 A1
(43) Pub. Date: Jul. 23, 2020

(54) System for Disposing of Gray Water

(71) Applicant: Hall Labs LLC, Provo, UT (US)

(72) Inventors: David R. Hall, Provo, UT (US); Michael Hall, Provo, UT (US); Steven J. M. Butala, Provo, UT (US); Jacob Dean, Provo, UT (US)

(73) Assignee: Hall Labs LLC, Provo, UT (US)

(21) Appl. No.: 16/252,385

(22) Filed: Jan. 18, 2019

(51) Int. Cl. C02F 9/00

(52) U.S. Cl. CPC C02F 9/00; C02F 1/001

(57) ABSTRACT

A gray water disposal system is disclosed. The system includes an inlet adapted to receive gray water and a vaporizer for discarding the gray water into the air. Preferably, the system includes a pump and a filter. Another aspect of the invention is using the system to dispose of gray water generated on a vehicle.

### TECHNICAL FIELD

The present application relates generally to fluid systems and, more particularly, to gray water systems.

### BACKGROUND

People generate gray water while doing such things as showering, washing dishes, or brushing teeth. Disposal of that gray water is easy when it drains into a sewage system, such as in a typical house. However, when there is no sewage system, such as in a camping trailer or in an off-grid home, the gray water typically is stored in a tank, which needs to be emptied. Emptying a gray water tank can be time consuming and burdensome, especially if an accompanying black water tank is not yet full.

### SUMMARY

A system for disposing of gray water comprising an inlet adapted to receive gray water, and a vaporizer for discarding the gray water into the air. Preferably, the system also includes a pump and a filter.

Another aspect of the invention is using the system to dispose of gray water generated in a vehicle.

Further aspects and embodiments are provided in the following drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is the top view of an embodiment of the water disposal system.

FIG. 2 is a perspective view of another embodiment of the water disposal system.

FIG. 3 is a side view of yet another embodiment of the water disposal system.

FIG. 4 is a side view of still yet another embodiment of the water disposal system.

FIG. 5 is a schematic view of another embodiment of the water disposal system.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well-known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “vapor” is meant to refer to a substance diffused or suspended, at least momentarily, in the air.

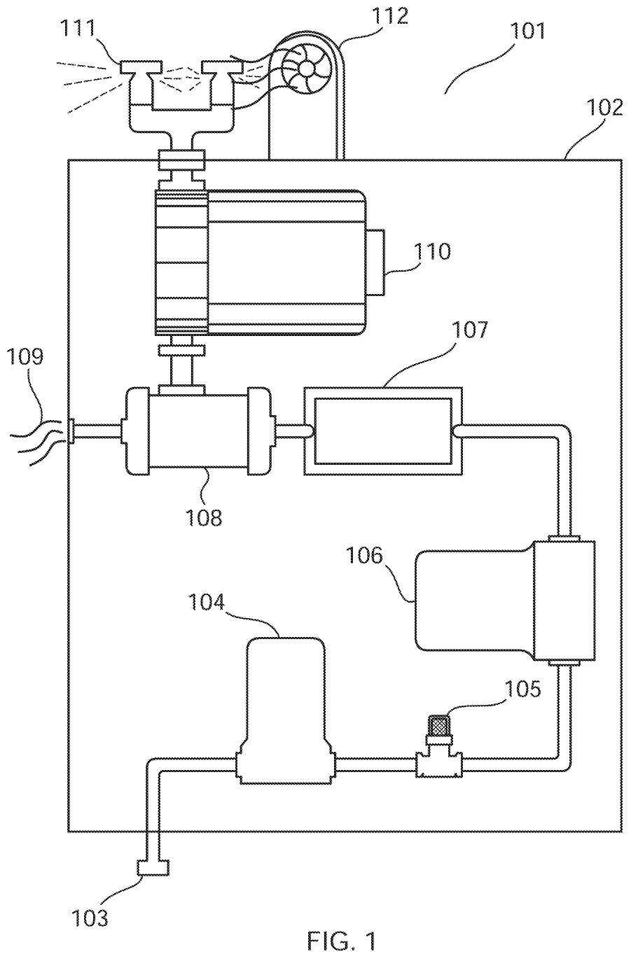

Now referring to FIG. 1, one embodiment of a gray water disposal system 101 is shown with an enclosure 102. As shown the enclosure 102 encases the components inside with an open top, however, the enclosure may also be covered with a wall or a door. Another embodiment of the invention has no enclosure.

The system includes an inlet, such as that shown at 103, which allows the system to be attached to a source of gray water, such as a tank, a pipe, or a hose. In other embodiments of the system, the inlet may be a bucket, the drain of a sink, or other types of inlets. In one embodiment of the invention, the source is made from anti-microbial materials or is coated with an anti-microbial treatment, which reduces or negates a need to kill microbes within the system. Once Gray water reaches the inlet 103, it flows inside the enclosure 102.

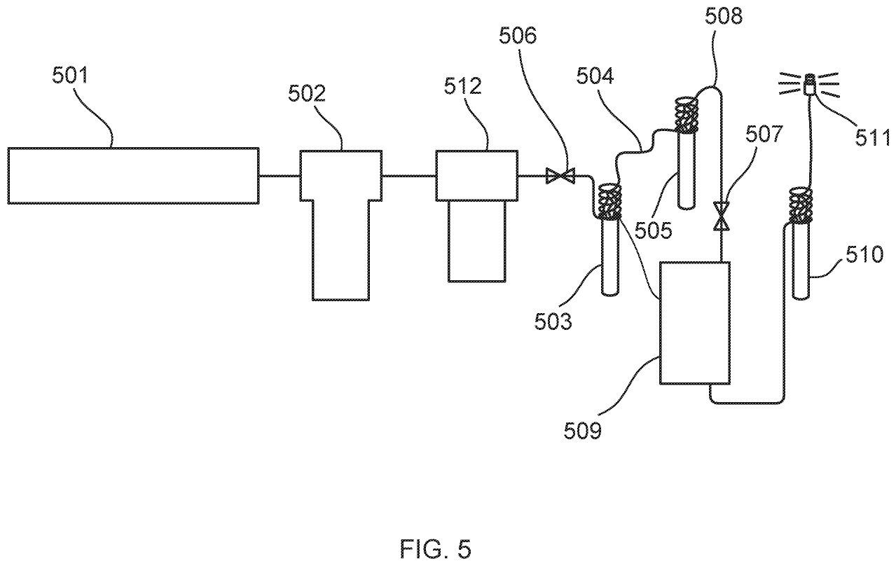

In the preferred embodiment, the system includes a pump for pumping gray water from the inlet. Preferably, the pump is a diaphragm pump 104, designed to pump gray water with suspended solids. Other pumps such as chopper pumps, grinder pumps, or other pumps that can handle solids may also be used. In an application where solids are not an issue, other pumps such as centrifugal pumps or other may be used. Further, other embodiments of the invention do not have a pump and are fed by gravity or some other means, one method being depicted in FIG. 5.

In some embodiments, the gray water is filtered. The filter can be as simple as a grate or strainer. It may also be as simple as a settling tank or a decanter. Preferably, the filter is configured to remove any solids that can interfere with the operation of the other system components. It may also be used to reduce the COD, (chemical oxygen demand), or the BOD (biological oxygen demand), of the water. In the preferred embodiment, two separate filters are used to filter different sized particles. A screen 105 is used to filter larger particles, and a small particle filter 106 is used to filter small particles, such as a ten-micron paper filter. In other embodiments, three or more filters may be used. In yet another embodiment, only one filter is used. In yet another embodiment, no filter is needed.

The filters used may use one or more of many types of filtering technologies. Filters may be physical filters as shown 105 and 106, which may use any of the available mediums for filtering, such as paper, sand, carbon, ceramic, diatomaceous earth, zeolite, or other. Filters may also use reverse osmosis, chemical filtering, biological filtering, or other. In one embodiment, flocculants, coagulants, or both may be used to prepare the solids to be more effectively filtered.

In the embodiment depicted in FIG. 1, an electrolysis unit 107 follows the filter. The electrolysis unit kills bacteria and other microorganisms before dispersion. Other types of sanitizing may be used, such as ultraviolet radiation, ozone, pasteurization. Additionally, antibacterial tubing may be used by itself or in addition to another sanitizer. Such tubing may be inherently antibacterial due to the material properties of the tubing, or it may have an antibacterial coating. Antibacterial tubing may also comprise traditional pipes and components organized in a manner to create a tortuous path to maximize surface area and turbulent flow, or it may also comprise a tortuous-path valve, tortuous-path filter, or another component configured to optimize surface area and mixing.

In some embodiments of the invention, a degasser 108 may be required. The degasser 108 removes vapors 109 from the flow of gray water. This may be necessary if components that are sensitive to vapors are down stream of the sanitizer, such as a centrifugal pump as shown in FIG. 1. This may especially be necessary if a sanitizer tends to create vapors from the gray water which is common with electrolysis, pasteurization, or other forms of sanitization.

In the embodiment depicted in FIG. 1, the sanitizer is placed between the filter and the degasser. In another embodiment of the invention, the sanitizer comes before the filter. In yet another embodiment, the sanitizer comes after the vaporizer. In yet another embodiment, the sanitizer and the vaporizer are the same step and are performed by the same component or process, such as a boiler, ultrasonic vaporizer, antibacterial misting nozzles, or other. In yet another embodiment, a sanitizer is not needed.

In the embodiment depicted in FIG. 1, the gray water is vaporized by pressurizing the gray water with a centrifugal pump 110 and forcing the gray water through misting nozzles 111. A fan 112 may be used to blow vapor away from the system. The pump is preferably a high-pressure pump which helps create a fine mist, however, a low-pressure pump may be used in an embodiment where the mist does not need to be as fine. Preferably, the pump is over 500 psi. Even more preferably, the pump is over 900 psi. Further, the vaporization step may be performed by other active and passive methods such as boiling, ultrasonic fogging, ultrasonic vaporization with transducers, evaporation. Preferably, the vaporizer is active and aided by thermodynamic and/or mechanical means.

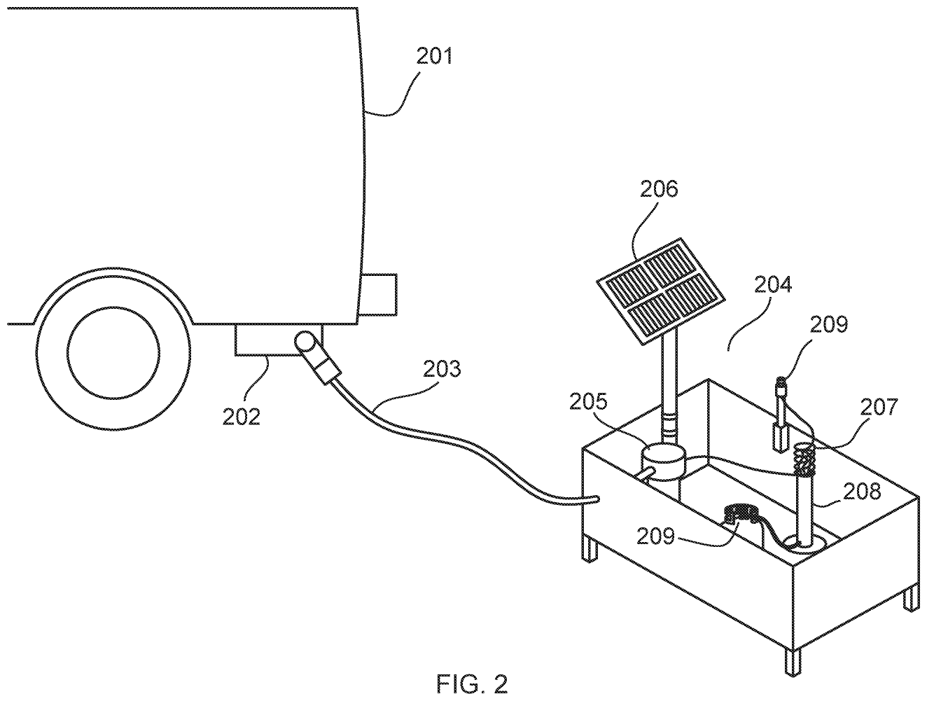

Now referring to FIG. 2, which depicts other embodiments of the invention, including removing the invention by a distance from the gray water source, and pasteurizing the gray water.

In some cases, the invention is best practiced away from the source of gray water or away from people. FIG. 2 shows one possible way to practice the invention with a recreational vehicle (RV) 201. A gray water basin 202 empties into a hose 203 which carries the gray water to another potentially distant location 204. The distant location may be as little as a meter from the RV, or it may be farther away such as 100 feet or more, depending on the situation and the length of the hose. Preferably, the hose has a length greater than 3 meters, more preferably greater than 6 meters, and most preferably greater than 10 meters.

The water may be fed to the distant location 204 by gravity, or it may be pumped. A pump may be near the gray water basin 202, or it may be at the distant location as shown 205, and draw the gray water creating a vacuum in the tube 203. The pump may be powered by solar panels 206, which may store energy in a battery, or which may power the pump directly. In other embodiments, the pump may be powered by a battery or by an electrical connection to the RV or other source.

As shown in FIG. 2, the gray water is sanitized by pasteurization. In one embodiment, the water is pasteurized in a tube coil 207 which is heated by a burner 208, which is attached to a source of fuel, such as a propane tank 209 or other. Other methods of sanitization may be used in place of or in addition to the pasteurizer, depending on resources. In other embodiments, the sanitization step may be omitted.

Finally, the gray water is vaporized. In one embodiment, the gray water is pushed through a mister 209. In other embodiments, other methods or devices may be used as described above.

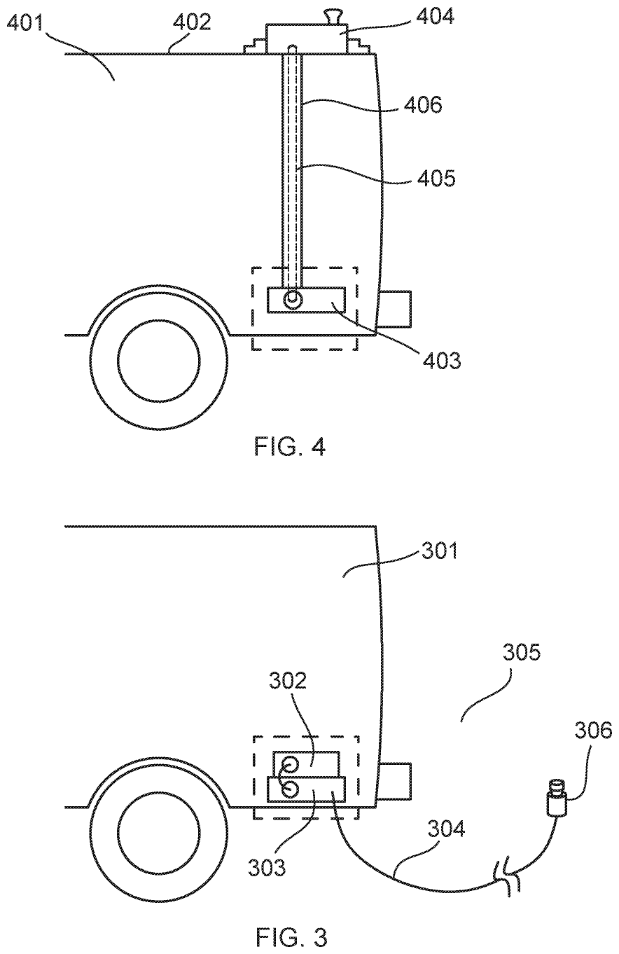

Now referring to FIG. 3, which shows another embodiment of the invention where the vaporization happens away from the source of the gray water.

In some instances, it may be beneficial to treat the water near the source of gray water, but perform the misting step at a distance from the source. In this embodiment, the gray water produced in an RV 301 is held in a basin 302. It is then treated by a gray water disposal unit 303. The water then flows by gravity, or is pumped through a long tube 304, to a remote location 305. The remote location may be a few feet from the gray water disposal unit 303, or much farther, such as 100 feet or more. In one embodiment, the gray water is vaporized by a misting nozzle 306. In other embodiments, the gray water is vaporized by other methods described above or other.

Now referring to FIG. 4, which shows one way the invention may be practiced on a vehicle roof. In one embodiment, the gray water produced on an RV 401 may be disposed of on a roof 402. In other embodiments, the roof may be of a house, building, or other structure. The water is pumped from a gray water source, such as a gray water basin 403, to a gray water treatment unit 404, which performs some or all of the invention. In one embodiment, the tube 405 connecting the basin 403 to the treatment unit 404 runs through the gray water basin vent 406. In one embodiment, gray water is vaporized while the RV 401 is in motion. In other embodiments, the RV 401 or other structure is stationary.

Now referring to FIG. 5, which shows an alternate method of moving the water through the system or a portion of the system.

Another embodiment of the invention uses water vaporization as a means of pressurizing the gray water to move it through the system. This may be helpful when electricity is scarce or unavailable, or other situations such as when a source of heat is the preferred driver for the system. This may also be helpful, in some embodiments, by combining a pressurization step and a sanitization step.

In one embodiment of the invention, a gray water source, such as a gray water basin 501, is in fluid communication with a pump 502. The pump could be a positive displacement pump or other type of pump configured to handle solids, or if solids are not an issue, it could be a centrifugal pump or other. In other embodiments of the invention, pumps which require no electricity may be used, such as a foot pump or other types of human powered pumps. In other embodiments of the invention, no pump is needed, such as when the gray water source is at an elevation or otherwise provides a pressure to make the gray water flow.

In one embodiment of the invention, the gray water passes through a filter as needed for the process. The filter may be a mechanical filter 503, or other, as described above.

In one embodiment of the invention, the gray water goes through a pressurization step where the gray water or a portion of the gray water is vaporized. This pressurization step comprises heating a portion of the gray water to expand its volume to create a pressure. The vaporization step may use a series of heaters to perform various tasks through the step. A heater may be a burner, such as a propane burner, or use another fuel. In other embodiments, the heater may be electric, use heat emitted by a fuel cell, or use another source of heat. In another embodiment of the invention, the heat may be waste heat from a heat pump, such as one used on a refrigerator or air conditioner, or another source of waste heat. In yet another embodiment, the heater may use a catalyst, such as a propane catalytic heater.

In one embodiment of the invention, a burner 503 separates a portion of the gray water by turning it to vapor and routing it through a separate path configured to superheat the gray water 504. The super heating path 504 may have another heater 505, which superheats the gray water to expand its volume even more than it already was. In one embodiment, the vapor is preferably heated to 500 degrees Fahrenheit. Even more preferably, the vapor is heated to 750 degrees Fahrenheit. Even more preferably, the vapor is heated to 1000 degrees Fahrenheit.

In one embodiment, two valves 506 and 507 on the superheating path 504 are closed to create a pressurization chamber 508. The valves 506 and 507 may be manually or electronically actuated. They may also open or close automatically, such as with check valves, pressure regulating valves, any combination thereof, or other.

The remainder of the gray water that is not vaporized, is routed to a storage chamber 509. The storage chamber may be a basin, length of tubing, or other container. If the storage chamber is a length of tubing, it may be organized in a coiled fashion or other space saving configuration.

As the vapor in the pressurization chamber 508 is heated, the pressure increases. In one embodiment of the invention, when the chamber 508 reaches a predetermined pressure, the valve 507 opens. This allows the pressurized gray water to enter the storage chamber and force the gray water out.

As the gray water exits the storage chamber, it passes through a sanitization step. The sanitization step may be performed by another burner 510, or it may be another method of sanitization as described above. In another embodiment, the sanitization step may be performed by the first burner 503. In other embodiments of the invention, the sanitization step is not needed.

In one embodiment of the invention, the gray water is finally vaporized. The vaporization may be forcing the water through a mister 511, or another method as described above.

The invention has been described with reference to various specific and preferred embodiments and techniques. Nevertheless, it is understood that many variations and modifications may be made while remaining within the spirit and scope of the invention.

What is claimed is:

1. A system for disposing of gray water comprising:
an inlet adapted to receive gray water;
and a vaporizer for discarding the gray water into the air.

2. The system of claim 1 further comprising a sanitizer adapted to sanitize the gray water.

3. The system of claim 1 further comprising a filter adapted to filter the water.

4. The system of claim 2 wherein the sanitizer is selected from the group consisting of an ozone generator, a heater, anti-bacterial tubing, an electrolysis unit, and combinations thereof.

5. The system of claim 2 further comprising a degasser which follows the sanitizer.

6. The system of claim 1 further comprising a feed pump configured to pump gray water through the system.

7. The system of claim 6 wherein the pump comprises:
a pressurization chamber, wherein a portion of the gray water is heated to create a pressurized portion of the gray water;
a valve system configured to allow the pressurized portion to push the remaining gray water through the system.

8. The system of claim 7, wherein the portion of gray water is heated in two stages.

9. The system of claim 1 wherein the vaporizer comprises a misting nozzle.

10. The system of claim 9 further comprising a hose adapted to carry the gray water and separate the misting nozzle from the inlet by a distance which allows the gray water to be discarded at a point distant from the inlet.

11. The system of claim 1 further comprising a fan to blow the gray water away from the vaporizer.

12. A system for disposing of gray water generated on a vehicle comprising:
an inlet adapted to receive gray water generated in the vehicle;
a filter adapted to remove solids from the gray water; and
a vaporizer for discarding the gray water into the air.

13. The system of claim 12 further comprising a sanitizer adapted to sanitize the gray water.

14. The system of claim 12 wherein the vaporizer comprises a misting nozzle.

15. The system of claim 12 further comprising a mounting mechanism for mounting the system to the top of the vehicle.

16. The system of claim 12 wherein the system is mounted below the vehicle such that the system is gravity-fed gray water from the vehicle.

17. The system of claim 12 further comprising a pump configured to move the gray water through the system.

18. The system of claim 17 wherein the pump is powered by a battery, which battery is charged by a solar panel.

19. The system of claim 17 wherein the pump comprises:
a pressurization chamber, wherein a portion of the gray water is heated to create a pressurized portion of the gray water;
a valve system, configured to allow the pressurized portion to push the remaining gray water through the system.

20. The system of claim 19, wherein the portion of gray water is heated in two stages.
